(19) United States
(12) Patent Application Publication
(10) Pub. No.: US 2023/0274606 A1
(43) Pub. Date: Aug. 31, 2023

(54) GAMING MACHINE INCLUDING JOYSTICK WITH VISUAL INDICATOR AND METHOD OF OPERATION THEREOF

(71) Applicant: Aries Technology LLC, Las Vegas, NV (US)

(72) Inventors: Ronnie W. Harris, Las Vegas, NV (US); David B. Schultz, Las Vegas, NV (US); Jason Cole, Las Vegas, NV (US)

(21) Appl. No.: 18/099,769

(22) Filed: Jan. 20, 2023

Related U.S. Application Data
(60) Provisional application No. 63/301,635, filed on Jan. 21, 2022.

(51) Int. Cl. G07F 17/32

(52) U.S. Cl. CPC G07F 17/3209; G07F 17/3211

(57) ABSTRACT

A gaming machine is provided. The gaming machine includes a monetary funds accepting mechanism for accepting monetary funds in creating a player credit balance, at least one display device, at least one player input device comprising a joystick, a memory device, a controller, and machine-readable code. The joystick includes a handle having a transparent or semi-transparent portion, and at least one light-emitting or generating element associated with the handle. The light-emitting or generating element is configured to emit light through the transparent or semi-transparent portion.

### RELATED APPLICATION DATA

This application claims priority to U.S. Provisional Application Ser. No. 63/301,635, filed Jan. 21, 2022, which application is incorporated herein by reference in its entirety.

### FIELD OF THE INVENTION

The present invention relates to gaming machines that include joysticks which are utilized to receive user inputs.

### BACKGROUND OF THE INVENTION

Gaming devices frequently utilize one or more player input devices such as joysticks. Conventional joysticks are generally configured to simply receive user input. A user may thus not know when such a joystick is enabled for use, what mode of operation the joystick might be in when the joystick has multiple modes of operation or the like.

### SUMMARY OF THE INVENTION

One aspect of the invention is directed to a gaming machine. The gaming machine comprises a monetary funds accepting mechanism for accepting monetary funds in creating a player credit balance; at least one display device; at least one player input device comprising a joystick, the joystick comprising: a handle having a transparent or semi-transparent portion, and at least one light-emitting or generating element associated with the handle, the at least one light-emitting or generating element being configured to emit light through the transparent or semi-transparent portion; a memory device; a controller; machine-readable code stored in the memory device and executable by the controller to, in response to a wager placed by a player from the player credit balance, cause the at least one display device to present wagering game information to the player; machine-readable code executable by the controller to cause the controller to cause the at least one light-emitting or generating element to provide one or more visual indications in relation to the wagering game; machine-readable code executable by the controller to cause the controller to accept input from the player via the joystick; and machine-readable code executable by the controller to cause the controller to determine an outcome of the wagering game with reference to the input from the player via the joystick.

Another aspect of the disclosed concept is directed to a gaming system where a joystick with one or more visual indicators is utilized in the play of one or more remote gaming machines. The one or more visual indicators may be used to provide an indication of the particular remote gaming machine being played, a mode of operation of the remote gaming machine, etc.

As another aspect of the disclosed concept, a method of operating the aforementioned gaming machine is provided. The method comprises providing the aforementioned gaming machine; presenting wagering game information to a player in response to a wager placed by the player from the player credit balance; providing one or more visual indications in relation to the wagering game with the at least one light-emitting or generating element; accepting input from the player via the joystick; and determining an outcome of the wagering game with reference to the input from the player via the joystick.

Further objects, features, and advantages of the present invention over the prior art will become apparent from the detailed description of the drawings which follows, when considered with the attached figures.

### DESCRIPTION OF THE DRAWINGS

FIG. 1 is an exemplary gaming machine comprising a joystick with visual indicator in accordance with an embodiment of the invention.

FIGS. 2A to 2E are various embodiments of a first type of joystick.

FIGS. 3A and 3B are embodiments of a second type of joystick.

FIG. 4 is an exemplary environment of use of a joystick of the invention.

FIG. 5 is a simplified view of a gaming system, in accordance with one non-limiting embodiment of the disclosed concept.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise joysticks with at least one visual indicator and methods of making, operating and using the same. In one embodiment, the joystick of the invention may be referred to as an “illuminated” joystick. Such illuminated joysticks have particular utility to gaming devices such as gaming machines which are configured to present wager-based games and/or amusement-based games. As described herein, one or more visual indicators of the joystick may provide an indication of a mode of operation thereof, such as a mode of operation relative to an associating gaming machine.

In this regard, embodiments of the invention have particular utility to gaming machines. Such a gaming machine may have various configurations. The gaming machine may be located at a casino and/or arcade. As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

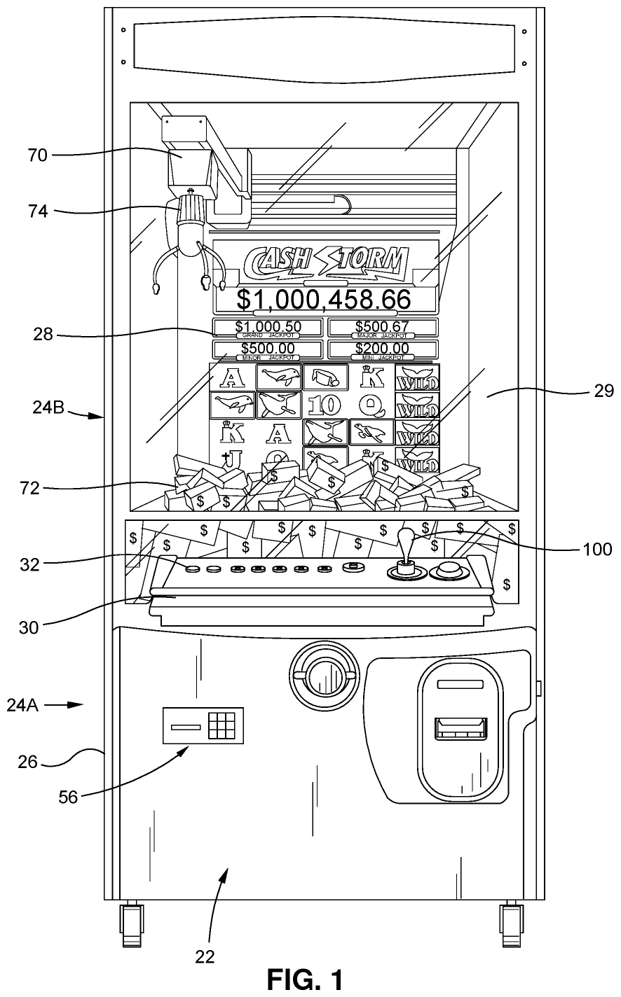

FIG. 1 illustrates one embodiment of a gaming machine 22 which includes at least one joystick with a visual indicator. In FIG. 1, the gaming machine 22 generally comprises a housing or cabinet 26 for supporting and/or enclosing various components required for operation of the gaming machine. In the embodiment illustrated, the housing 26 is generally “box” shaped, having a front (which the player faces) and an opposing back, a right side and a left side (when facing the front), and a top and a bottom. However, the housing 26 could have other configurations, as noted below.

The housing 26 may have one or more enclosed or generally secure areas. For example, the housing 26 may include a first lower secure area 24A for housing one or more first components of the gaming machine 22, such as a processor, bill validator (and associated ticket or cash box), and other features. The housing may also include a second upper secure area 24B, such as for housing portions of an amusement game unit of the gaming machine 22, as described in more detail below (which may thus be referred to as the “amusement game area”).

As noted, in a preferred embodiment, the gaming machine 22 is a dual unit that has one or more features or components for presenting a casino-style wagering game and one or more features or components for presenting an amusement-type game.

In general, in order to present casino-style wagering games, the gaming machine 22 includes one or more monetary funds-accepting mechanisms for accepting monies or monetary value or otherwise allowing a player to wager monies or monetary value, and features which cause the gaming machine 22 to present a wagering game to a player, such as by displaying wagering game information. Certain wagering game outcomes (but preferably not all game outcomes) may be designated as winning outcomes (the non-winning outcomes may be referred to as losing outcomes), wherein prizes or awards may be provided for winning outcomes, such as monetary payments (or representations thereof, such as prize of credits). As such, the gaming machine 22 preferably includes a mechanism or means for returning unused monetary funds and/or dispensing winnings to a player, as described in more detail below.

In order to present or display wagering game information to a player, the gaming machine 22 includes at least one display device 28. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display device 28 may be capable of projecting or displaying a wide variety of information, including images, symbols and other indicia or information associated with game play (e.g., a wagering game), game promotion or other events. The display device 28 might comprise a single flat panel display, and might have other configurations, such as being a curved display (in this case, curved about its vertical axis).

While the display device may comprise one or more video displays, in another embodiment, the gaming machine 22 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a player causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depressing a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

The gaming machine 22 preferably includes one or more player input devices 32 to enable a player to play a wagering game (such as input buttons, plunger mechanisms, a touch-screen display, touch-pad, or the like). One embodiment of the player input device may be a joystick 100. These one or more input devices 32 may be utilized by the player to facilitate wagering game play, such as by providing input or instruction to the gaming machine 22. For example, such input devices 32 may be utilized by a player to place a wager, cause the gaming machine 22 to initiate a game, to initiate a reel spin, to “cash out” of the gaming machine, or to provide various other inputs, such as to buy a game card, and/or daub a card and claim winnings, such as in a game of bingo. In one embodiment, a touch-screen may be associated with the second area 24B of the gaming machine 22. For example, as illustrated in FIG. 1, a touch-screen 29 might be associated with a front glass or other transparent panel or display of the second or upper area 24B, whereby the player could provide input by touching the enclosure of the second area 24B in front of them. Of course, in other embodiments, the deck 30 might incorporate one or more displays having a touch screen or otherwise include a touch screen.

In one embodiment, one or more of the player input devices 32 are utilized to facilitate play of an amusement-style event. These input devices 32 may comprise one or more of the input devices which are used to present the casino-style wagering game, but may also comprise one or more different input devices. The amusement-style events may comprise a mechanical output event that is configured to selectively move objects, such as a crane event or a coin-pusher event. In the crane event, a player attempts to guide a crane or claw to a position and then use the crane or claw to grab an object, such as a prize. In the coin-pusher event, the player attempts to guide a coin onto a location of a coin platform such that a moving coin pusher pushes one or more coins off of the platform. In the case of the crane event, the player input devices 32 may thus comprise a crane control such as a joystick 100 which communicate player inputs thereto to the processor, which then generates corresponding control instructions for output to the joystick 100 (which may control one or more motors or the like for changing the location of the crane, dropping a claw of the crane, closing a bucket or claw of the crane, etc.). In the case of the coin-pusher event, the player input device 32 might comprise a movable coin launcher which enables a player to direct a coin to a desired location by rolling the coin down a slot of a guiding device. Such a launcher may comprise a guide which is mechanically mounted to the gaming machine 22. Of course, the amusement-style event might comprise any number of other events now known or later developed, and might comprise pinball type events, Pachinko type events, skee-ball, shooting or target events, scoop crane type events, or others.

The gaming machine 22 may further comprise one or more amusement-style event presentation elements. As illustrated in FIG. 1, in one embodiment, the gaming machine 22 may be configured to present a crane amusement event. In this configuration, one or more crane elements are preferably located in the second or upper area 24B of the gaming machine 22. As illustrated, the second area 24B is preferably generally enclosed to define an interior area. Moreover, the second or upper area 24B may be at least partially enclosed by one or more transparent panels so that the interior of the area is visible to the player. Inside of the second area 24B may be located a crane 70 and one or more prizes 72. The crane 70 may comprise a claw 74, and is located above the prizes 72, which may be located at a bottom of the second area 24B. Play or presentation of the crane event is described in more detail below. Prizes might be located in the prize area in various ways, including by being piled or stacked on a base of the second area 24B, or by being located on a stand or rotating platform in the second area 24B. In one embodiment, the gaming machine 22 may simply be a stand-alone amusement game machine.

As indicated, the gaming machine 22 preferably includes one or more player input devices. The one or more player input devices may be used by a player to provide inputs relate to the presentation of one or more games presented by the gaming machine 22, such as a wagering game or an amusement-type game. In one embodiment, the one or more player input devices include a joystick 100 of the invention. The joystick 100 might be used, for example, to receive player inputs relative to the presentation of the “crane” type amusement or wagering game event. Of course, the types of inputs might vary depending upon the particular game, games or other events presented by the gaming device 22. Further, the joystick 100 might be used to provide input relative to other devices or system, such as those linked to the gaming machine 22. As one example, the joystick 100 might be used to receive a player's input regarding a system-wide tournament type event, a game or games presented remotely (such as by other devices), etc.

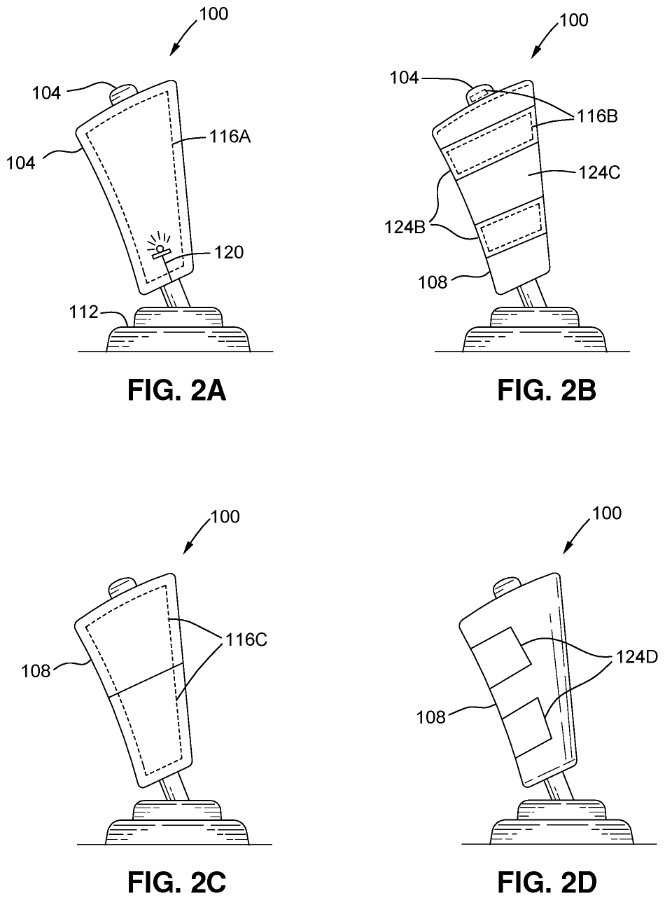

FIG. 2A illustrates an embodiment of an illuminated joystick 100. In this example, the joystick 100 comprises one or more buttons 104, a handle 108, and a base 112. The button 104 may be attached to the handle 108. Where more than one button 104 is attached, the buttons may be distributed at various locations on the handle 108 such as at the top or around the body where a player's fingers can easily access the buttons 104. The bottom portion of the handle 108 may be movably attached to the base 112 (such as via a pivotal, ball-socket or other type of movable mounting), such that the top portion of the handle 108 may be moved in various directions (such as forward, backwards, left, right, or in circles). The button 104 may be any shape or size and may be of various types (mechanical plunger, capacitive touch, etc.). Similarly, the handle 108 may be in any shape or size (such as larger handles for player input using the player's entire hand, or smaller handles for player input using a finger), and may comprise a hollow portion or interior 116A to house one or more internal devices and/or mechanisms. Internally, the illuminated jackpot 100 may comprise one or more I/O (input receiving and generating) mechanisms, which may be connected to the one or more buttons 104.

In one embodiment, one or more light-emitting or generating elements 120 are associated with the handle 108, such as by being located in or communication with, the interior portion 116A of the handle 108, such as for illuminating portions of the handle 108. As one example, one or more LEDs or other light emitting or generating elements may be provided. In FIG. 2A, the light-emitting or generating element 120 may be located at the bottom portion of the hollow portion 116A. However, it is contemplated that the light-emitting or generating element 120 may be located anywhere in the hollow portion 116A or be in communication therewith (such as via a light tube, fiber optic cable or other transmission element, etc.). In the embodiment illustrated in FIG. 2A, the handle 108 may be constructed using any material comprising a level of transparency (such as plastic, silicone, or glass) to make the light-emitting or generating element 120 at least partially visible and/or whereby at least a portion of the handle 108 is illuminated. For example, one or more portions of the handle 108 might be molded from a generally transparent plastic material, which portions are illuminated by the light-emitting or generating element(s) 120 in the interior 116A. 915

FIG. 2B illustrates another embodiment of an illuminated joystick 100. In accordance with this example, the hollow portion or interior 116B may be inside the button 104 and/or in parts or portions of the handle 108. For example, the handle 108 may comprise of one or more rings made out of transparent material 124B while the remaining portions are made out of another material which is generally opaque or otherwise blocks light. In other words, the handle 108 includes the annular-shaped ring 124B and a remaining portion 124C that is generally opaque. The light-emitting or generating element 120 may be located in the button 104 and/or in proximity to or in communication with the portions on the handle 108 made out of transparent material 124B.

FIG. 2C illustrates another embodiment of an illuminated joystick. In this example, the interior portion of the handle 108 may comprise one or more separate hollow compartments 116C. One or more light-emitting or generating elements 120 may again be associated with the handle 108, such as the separate interior portions, such as for illuminating those portions. In one embodiment, different light-emitting or generating elements 120 may be associated with the different interior compartments 116C, such as for illuminating different portions in different manners (such as different colors), e.g., each emitting light through a corresponding one of the compartments 116C. For example, a top portion may be illuminated in a first color (such as green) to provide a visual cue to the player prompting input using the joystick 100, while a bottom portion may be illuminated in another color (such as red) to notify the player that input is no longer needed.

FIG. 2D illustrates another embodiment of the an illuminated joystick 100. In this example, the light-emitting or generating element(s) 120 may be visible through “windows” 124D, which may comprise of partial patches of transparent materials on the handle 108. FIG. 2E illustrates another embodiment of the illuminated joystick 100, where the windows 124E may be in the shape of letters, which may be illuminated with the same or different colors.

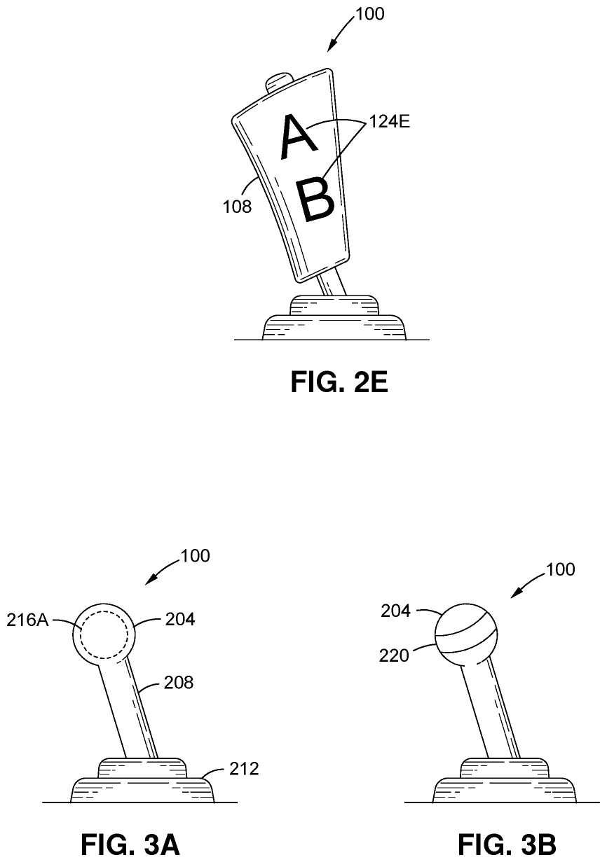

FIG. 3A illustrates another embodiment of an illuminated joystick 100. In this example, a top portion 204 of the handle may be a different shape than a bottom portion 208. The hollow portion or interior 216A which contains the one or more light-emitting or generating element 120 may be found in the top portion 204 of the joystick 100, so as to appear illuminated at one or more times, while the bottom portion 208 may or may not be illuminated.

FIG. 3B illustrates another embodiment of an illuminated joystick 100, where the top portion 204 of the handle is only partially illuminated, such as via an illuminated ring 220 (described in more details above and illustrated in FIG. 2B—124B).

While in the above-described embodiments the one or more light-emitting or generating elements may be located within (or communicate with an interior portion of) the handle, the one or more light-emitting or generating elements might be associated with the handle in other manners. For example, in some embodiments, one or more insets might be provide in the exterior of the handle and the light emitting element might be located in the inset (for example, an LED might be located in a recess or inset in the handle, such that the LED emits light directly outwardly of the handle).

It will be appreciated that the joystick of the invention may have various shapes and configurations and include or communicate with one or more light-emitting or generating elements in various manners, whereby the joystick has a visual indication feature. In one embodiment, the visual indication may comprise the illumination of one or more of the light-emitting elements, such as at certain times or in certain manners (such as steady, blinking, combinations of lights which are on/off), in certain colors or combinations of colors or the like. These different illumination features may, as described below, provide a visual indication to a user/player, such as of a condition of the joystick, an associated game, etc.

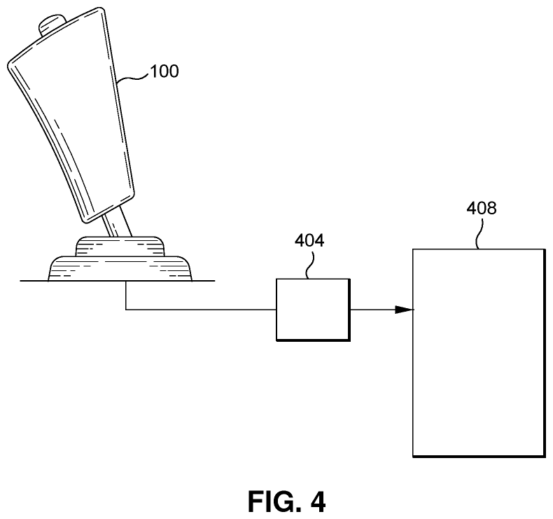

FIG. 4 illustrates one exemplary environment of use of the joystick 100. The joystick 100 may be electronically connected to a controller 404. In some embodiments, the controller 404 may be connected to a master controller 408, such as a master gaming controller of a gaming machine. For example, the controller 404 might be a main controller or a sub-controller, such as a USB sub-controller which is associated with a main controller. The joystick 100 may be wired or wireless, wherein the elements of the joystick 100 may communicate with the controller 404, or the controller 404 might communicate with the master controller 408, via a wired or wireless communication path. In one embodiment, the joystick 100 is wired, such as to provide power thereto for use in illuminating the one or more light-emitting or generating elements.

The controller 404 may be used to send player input to the gaming machine. As indicated, such inputs might be based upon movement of the joystick 100 and/or input to the one or more buttons associated therewith. The controller 404 may be configured to execute machine readable code or “software” or otherwise process information, such as obtained from a remote server. Software or other instructions may be stored at a memory or data storage device, e.g. in a fixed or non-transitory configuration.

The master controller, such as a master gaming controller 408, may be configured to control the gaming machine 22 (or other device), including receiving player input (such as from the controller 404) and sending output signals for controlling the various components or peripheral devices of the gaming machine 22 (such as generating game information for display by the display devices 28,30). The display devices 28,30 may also be configured to emit an array of light having a color, and the light-emitting or generating elements 120 may, at the same time, be configured to emit an array of light having the same color.

Moreover, the controller 408 may be arranged to receive information regarding funds provided by a player to the gaming machine 22, receive input such as a purchase/bet signal when a purchase/bet button is depressed, and receive other inputs from a player. The controller 408 may be arranged to generate information regarding a game, such as generating game information for display by the at least one display device 28,30 (such as information comprising slot game symbols, images of playing cards or other game information), for determining winning or losing game outcomes and for displaying information regarding awards for winning game outcomes, among other things.

The master gaming controller 408 may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information including tracked game play information). The gaming machine 22 may also include one or more random number generators for generating random numbers (such as implemented by a random number generator software module stored in the memory and executable by the processor), such as for use in selecting slot symbols, playing cards and the like, and for presenting the game in a random fashion (e.g. whereby the game is presented in a manner in which the player cannot control the outcome) or pseudo-random fashion (e.g. such as where the game includes a skill component which can affect the outcome of the game).

Preferably, the master gaming controller 408 is configured to execute machine readable code or instructions (e.g. software) which are configured to implement the game. In this regard, the gaming machine 22 may be specially configured to present one or more games via specific software and/or hardware which causes the gaming machine to operate uniquely. For example, the controller of the gaming machine 22 may be configured to detect a wager, such as a signal from a player's depressing of the “bet one” button (such as one of the buttons 32). Upon such an event and/or the player otherwise signaling the gaming machine to present the game, the controller may be configured to cause the at least one display 28 to display unique information, such as a unique graphical interface or unique game display, including game symbols or other game information (such as graphically represented images of cards, slot symbols, dice, etc.). The controller may accept input from a player of game inputs, such as a request to spin reels or the like, via the one or more player input devices of the gaming machine 22. As indicated above, the machine-readable code may be configured in various manners, such as by having various “modules” of software which are designed to implement specific features of the game play or game presentation.

In one embodiment, the master controller 408, such as the master gaming controller 408, may send signals to the controller 404 (and thus the joystick 100) to cause it to operate in particular manners, such as at particular times. As one example, relative to the gaming machine 22 illustrated in FIG. 1 and described above, a player might play a wagering game, such as by placing a wager and having the gaming machine 22 present wagering game information (and an associated outcome). At one or more times, the amusement portion of the gaming machine 22 may be activated. During the time the amusement portion of the gaming machine 22 is inactive, the one or more visual indicators of the joystick 100 might be configured to provide an indication that the joystick 100 is inactive. This might comprise, for example, not illuminating any of the light-emitting elements, or causing them to illuminate a red color. When the amusement portion of the gaming machine 22 is active, the one or more visual indicators of the joystick 100 might be configured to provide an indication of such. This might comprise illuminating one or more of the light-emitting elements, such as by turning them on or causing them to blink, to cause them to emit green light, etc.

Of course, the light-emitting elements might be used to provide other visual indications. As one example, during the play of an amusement type crane game, the player may have a certain limited time in order to move the crane to a desired position. The light emitting elements might be turned on at the start of the time and then flash with increasing frequency as the time period gets closer to expiring (and might then be turned off), or the color of the light emitted might change from green to yellow to red, etc.

As further examples, the visual indicator(s) of the joystick might be used to provide other information, such as other information regarding one or more modes of operation. As one example, the indicators might be used to indicate available directions of movement or input of the joystick, such as red for left-right only, green for up and down only, etc. (depending upon the configuration of the joystick which defines the various manners of input thereof).

In one embodiment, the one or more indicators may be synced with information which is displayed by one or more lights of the gaming machine and/or the one or more displays thereof. For example, during a particular mode of operation, lights of the gaming machine may be illuminated red while the visual indicator(s) of the joystick are also illuminated red.

In a preferred embodiment, the joystick may be attached to and/or used on electronic gaming devices and/or amusement-type devices, but it will be appreciated that the joystick may be used on other entertainment devices such as gaming consoles. In such instances, the machine readable code executed by the controller 404 may be replaced or updated to be compatible with the master gaming controller 408 of such entertainment devices. The joystick may also be used on practical tools such as to drive a vehicle or to operate various tools in transportation, construction, and/or to perform cosmetic or medical procedures. In such instances, the machine readable code executed by the controller 404 may be replaced or updated to be compatible with the various controllers and/or systems used in such vehicles or tools.

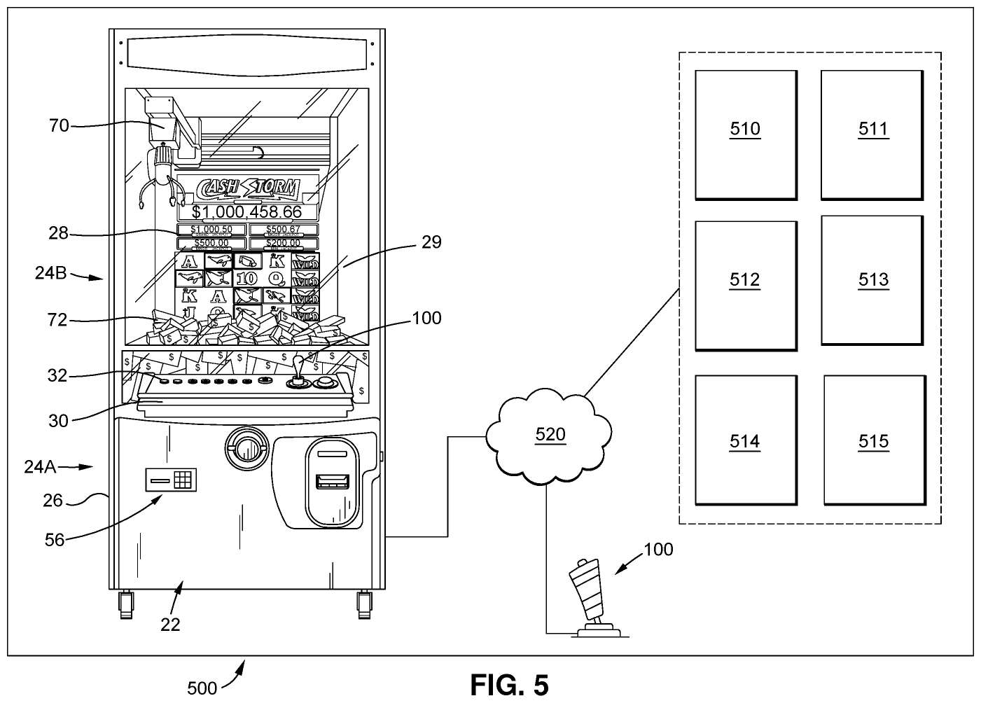

In another example embodiment of the disclosed concept, FIG. 5 shows a simplified view of an example gaming system 500. The system 500 includes the gaming machine 22, described above, and a plurality of other gaming machines 510-515. In one example embodiment, the first gaming machine 22, or at least the joystick 100 thereof, is communicatively coupled to one or more of the other gaming machines 510-515, such as via one or more wired and/or wireless communication links 520, which links may include WANs, LANs, the Internet, etc., including other devices such as intermediate servers, etc. (for example, in a promotional embodiment, a promotional server might award a player of a first gaming machine 22 a promotional award which allows the player to play one of the remote gaming machines 510-555 for a promotional award, wherein the configuration of the visual indicators of the joystick 100 may be controlled by the promotional server and the player's inputs to the joystick 100 might be provided through the promotional server to the assigned remote gaming machine 510-555). The other gaming machines 510-515 are spaced or remote from the first gaming machine 22 and might be located in a different area of the same casino, in a different casino or other location.

In one embodiment, input to the joystick 100 of the first gaming machine 22 may be used to provide input to one of the other gaming machine 510-515. For example, at least one of the other gaming machines 510-515 may include amusement or other game elements, such as for selectively moving at least one object, as described above. In a remote play configuration, the display device 28,30 of the first gaming machine 22 may be configured to display a visual indication of any one of the other gaming machines 510-515, such as captured by a camera associated with the other gaming machine 510-515 (which may be connected to or mounted to the other gaming machine or might be external thereto). In this manner, the player may be able to see what is happening with the other gaming machines 510-515 when he or she is remotely controlling it with the joystick 100.

As one example, a player of the gaming machine 22 might enter a bonus mode which allows them to play one of the remote gaming machines 510-555, or they might be awarded a promotional game or reward which allows them to play one of the remote gaming machines 510-555, such as described in U.S. Pat. No. 11,107,325, which is incorporated herein by reference in its entirety.

In yet another embodiment, the joystick 100 of the invention might be separate from a gaming machine, but used to control a remote gaming machine 510-515. For example, the joystick 100 might be associated with a console, placed on a desk, be associated with a computing device or the like, where input to the joystick 100 might be used to play the remote gaming machine 510-555. In such a configuration, a communication link is provided between the joystick 100, such as the controller thereof, and the remote gaming machine 510-555. Of course, such a link might be provided by a web-browser (such as where the joystick 100 is web-enabled), by a secondary communication link or the like.

In one embodiment, the one or more visual indicators of the joystick 100 may provide various information, such as regarding a mode of operation which relates to the one or more remote gaming machines 510-555. As one example, different of the remote gaming machines 510-555 might be designated by different colors, where a color of the light illuminated by the indicator(s) of the joystick 100 may identify the particular remote gaming machine which the joystick is linked to (e.g. red light on the joystick indicates a link to the red or red lighted remote gaming machine, etc.). In other embodiments, the visual indicators of the joystick 100 might indicate “prize” modes, such as where red light indicates that “red” level prizes may be won, a green light may indicate that “green” level prizes may be won, etc. —where the remote gaming machine 510-555 may then be controlled so that only prizes of the corresponding level may be awarded or won. As one example of the invention, different ones of the remote gaming machines 510-555 might offer prizes of different levels (red—Rolex watches, green—Nike Jordan shoes, etc.). The player of the main gaming machine 22 might be awarded a bonus involving the play of one of the remote gaming machines. The visual indicator of the joystick might blink red, indicating that the player has been awarded a play of the “red” remote gaming machine 510-555 which offers the player a chance to win a Rolex watch—such as via capture of one of the watches via an object selecting element (e.g. claw, crane, etc.) thereof. Further, during play of that remote gaming machine, the red indicators of the joystick 100 might blink during the time the player has the opportunity to move the remote object selecting element, etc.

In another example, a method of operating the gaming machine 22 includes the steps of providing the gaming machine 22, presenting wagering game information to a player in response to a wager placed by the player from the player credit balance, providing one or more visual indications in relation to the wagering game with the at least one light-emitting or generating element 120, accepting input from the player via the joystick 100, and determining an outcome of the wagering game with reference to the input from the player via the joystick 100.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a monetary funds accepting mechanism for accepting monetary funds in creating a player credit balance;
at least one display device;
at least one player input device comprising a joystick, said joystick comprising:
a handle having a transparent or semi-transparent portion, and
at least one light-emitting or generating element associated with said handle, said at least one light-emitting or generating element being configured to emit light through the transparent or semi-transparent portion;
a memory device;
a controller;
machine-readable code stored in said memory device and executable by said controller to, in response to a wager placed by a player from said player credit balance, cause said at least one display device to present wagering game information to said player;
machine-readable code executable by said controller to cause said controller to cause said at least one light-emitting or generating element to provide one or more visual indications in relation to said wagering game;
machine-readable code executable by said controller to cause said controller to accept input from said player via said joystick; and
machine-readable code executable by said controller to cause said controller to determine an outcome of said wagering game with reference to said input from said player via said joystick.

2. The gaming machine according to claim 1, wherein said handle further has an interior portion, and wherein said at least one light-emitting or generating element is disposed in or is in communication with the interior portion.

3. The gaming machine according to claim 2, wherein said one or more visual indications comprise light being emitted through the transparent or semi-transparent portion.

4. The gaming machine according to claim 3, wherein said at least one light-emitting or generating element comprises at least one light-emitting diode (LED).

5. The gaming machine according to claim 3, wherein said transparent or semi-transparent portion comprises at least one annular-shaped ring, and wherein said handle further comprises a remaining portion other than said at least one annular-shaped ring, said remaining portion being generally opaque.

6. The gaming machine according to claim 3, wherein said interior portion comprises a first compartment and a second compartment separate from the first compartment, and wherein said at least one light-emitting or generating element comprises a first light-emitting or generating element and a second light-emitting or generating element each disposed in a corresponding one of the first and second compartments and configured to emit light through the corresponding first and second compartments.

7. The gaming machine according to claim 6, wherein the first light-emitting or generating element is configured to emit a first color of light, and wherein the second light-emitting or generating element is configured to emit a second color of light, the first color being different from the second color.

8. The gaming machine according to claim 3, wherein said handle further comprises a top portion and a bottom portion extending from the top portion, wherein the top portion has a different shape than the bottom portion, and wherein said at least one light-emitting or generating element is disposed in the top portion, so as to appear illuminated at one or more times, while the bottom portion is not illuminated.

9. The gaming machine according to claim 8, wherein the transparent or semi-transparent portion is an illuminated ring disposed about the top portion such that the top portion of the handle is configured to be only partially illuminated by said at least one light-emitting or generating element.

10. The gaming machine according to claim 3, wherein said at least one display device is configured to emit a first array of light having a color, and wherein said at least one light-emitting or generating element is configured to emit a second array of light having a color the same as the color of the array of light of said at least one display device, and at the same time as said first array is being emitted.

11. The gaming machine according to claim 3, wherein said gaming machine further comprises a mechanical output event electrically connected to said controller, and wherein, responsive to said controller accepting input from said player via said joystick, said mechanical output event is configured to selectively move at least one object.

12. The gaming machine according to claim 11, wherein said mechanical output event is selected from the group consisting of a crane event, a coin-pusher event, a pinball type event, a Pachinko type event, a skee-ball event, a target-shooting event, and a scoop-crane type event.

13. The gaming machine according to claim 3, wherein said at least one display device comprises a video display electrically connected to said joystick, and wherein said video display is configured to display images and symbols associated with said wagering game.

14. A gaming system comprising:
a first gaming machine comprising:
a monetary funds accepting mechanism for accepting monetary funds in creating a player credit balance,
at least one display device,
at least one player input device comprising a joystick, said joystick comprising:
a handle having a transparent or semi-transparent portion, and
at least one light-emitting or generating element associated with said handle, said at least one light-emitting or generating element being configured to emit light through the transparent or semi-transparent portion,
a memory device,
a controller,
machine-readable code stored in said memory device and executable by said controller to, in response to a wager placed by a player from said player credit balance, cause said at least one display device to present wagering game information to said player,
machine-readable code executable by said controller to cause said controller to cause said at least one light-emitting or generating element to provide one or more visual indications in relation to said wagering game,
machine-readable code executable by said controller to cause said controller to accept input from said player via said joystick, and
machine-readable code executable by said controller to cause said controller to determine an outcome of said wagering game with reference to said input from said player via said joystick; and
a plurality of other gaming machines wirelessly connected to said first gaming machine and spaced from said first gaming machine,
wherein said controller of said first gaming machine is configured to control at least one of said plurality of other gaming machines.

15. The gaming system according to claim 14, wherein said at least one of said plurality of other gaming machines comprises a mechanical output event configured to selectively move at least one object.

16. The gaming system according to claim 14, wherein said at least one display device of said first gaming machine is configured to display a visual indication of said at least one of said plurality of other gaming machines.

17. The gaming system according to claim 14, wherein said handle further has an interior portion, and wherein said at least one light-emitting or generating element is disposed in or is in communication with the interior portion.

18. The gaming system according to claim 17, wherein said one or more visual indications comprise light being emitted through the transparent or semi-transparent portion.

19. The gaming system according to claim 18, wherein said at least one light-emitting or generating element comprises at least one light-emitting diode (LED).

20. A method of operating a gaming machine comprising the steps of:
providing the gaming machine with a monetary funds accepting mechanism for accepting monetary funds in creating a player credit balance, at least one display device, and at least one player input device comprising a joystick, wherein said joystick comprises a handle having a transparent or semi-transparent portion, and at least one light-emitting or generating element associated with said handle;
presenting wagering game information to a player in response to a wager placed by said player from said player credit balance;
providing one or more visual indications in relation to said wagering game with said at least one light-emitting or generating element;
accepting input from said player via said joystick; and
determining an outcome of said wagering game with reference to said input from said player via said joystick.
